(19) United States
(12) Patent Application Publication
(10) Pub. No.: US 2025/0077015 A1
(43) Pub. Date: Mar. 6, 2025

(54) CONTROL METHOD, CONTROL APPARATUS, AND ELECTRONIC DEVICE

(71) Applicant: Lenovo (Beijing) Limited, Beijing (CN)

(72) Inventors: Shuhui CAI, Beijing (CN); Xiangfeng SONG, Beijing (CN)

(21) Appl. No.: 18/821,322

(22) Filed: Aug. 30, 2024

(30) Foreign Application Priority Data
Aug. 31, 2023 (CN) 202311118981.5

(51) Int. Cl. G06F 3/041

(52) U.S. Cl. CPC G06F 3/0416

(57) ABSTRACT

A control method includes obtaining screen change information of an electronic device and configuring a touch display area of the electronic device at least based on the screen change information to respond to a target touch operation using the configured target touch display area. The target touch display area is at least a part of display area of the display screen of the electronic device.

### CROSS-REFERENCE TO RELATED APPLICATION

The present disclosure claims priority to Chinese Patent Application No. 202311118981.5, filed on Aug. 31, 2023, the entire content of which is incorporated herein by reference.

### TECHNICAL FIELD

The present disclosure relates to the information technology field and, more particularly, to a control method, a control apparatus, and an electronic device.

### BACKGROUND

Currently, an electronic device is often connected to a plurality of touch screens. However, the plurality of touch screens are controlled separately. The interface of an application is only displayed on one touch screen. A user can only operate the application on the touch screen.

### SUMMARY

The present disclosure provides a control method. The method includes obtaining screen change information of an electronic device and configuring a touch display area of the electronic device at least based on the screen change information to respond to a target touch operation using the configured target touch display area. The target touch display area is at least a part of display area of the display screen of the electronic device.

The present disclosure provides a control apparatus including an acquisition module and a configuration module. The acquisition module is configured to obtain screen change information of an electronic device. The configuration module is configured to configure a touch display area of the electronic device at least based on the screen change information to respond to a target touch operation using the configured target touch display area. The target touch display area is at least a part of display area of a display screen of the electronic device.

The present disclosure provides an electronic device including a display screen, a touch controller, and a processor. The processor is configured to obtain screen change information of the electronic device and configure a touch display area of the electronic device at least based on the screen change information to respond to a target touch operation using the configured target touch display area. The target touch display area is at least a part of display area of the display screen of the electronic device.

### BRIEF DESCRIPTION OF THE DRAWINGS

FIG. 1 illustrates a schematic flowchart of a control method according to some embodiments of the present disclosure.

FIG. 2 illustrates a schematic structural diagram of an electronic device including a plurality of screens according to some embodiments of the present disclosure.

FIG. 3 illustrates a schematic structural diagram of a display area of a display screen of an electronic device according to some embodiments of the present disclosure.

FIG. 4 illustrates a schematic flowchart of another control method according to some embodiments of the present disclosure.

FIG. 5 illustrates a schematic flowchart of another control method according to some embodiments of the present disclosure.

FIG. 6 illustrates a schematic structural diagram of a control apparatus according to some embodiments of the present disclosure.

FIG. 7 illustrates a schematic hardware structural diagram of an electronic device according to some embodiments of the present disclosure.

### DETAILED DESCRIPTION OF THE EMBODIMENTS

To make the purpose, technical solution, and advantages of embodiments of the present disclosure clear, the technical solutions of embodiments of the present disclosure are described in detail in connection with the accompanying drawings of the present disclosure. Described embodiments are some embodiments of the present disclosure not all embodiments. Based on embodiments of the present disclosure, all other embodiments obtained by those skilled in the art without creative efforts are within the scope of the present disclosure.

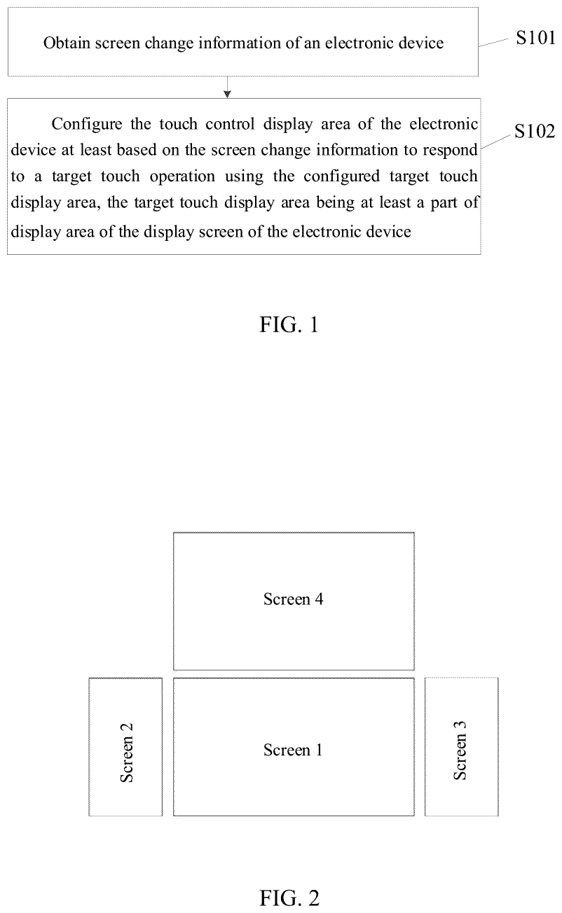

Embodiments of the present disclosure provide a control method. As shown in FIG. 1, the method includes the following processes.

At S101, screen change information of an electronic device is obtained.

In some embodiments, the screen change information can include but is not limited to screen size change information, screen pose change information, screen resolution change information, etc.

In some embodiments, the screen change information can be obtained through a touch screen driver, a specific application, or a related sensor (such as an angle sensor, an infrared sensor, a camera, etc.) of the electronic device. For example, in the interface of the touch screen driver or a specific application, parameters such as the size and resolution of the display area that needs to be touched can be manually adjusted to obtain the screen change information of the electronic device. For another example, the touch control driver can recognize the application startup through the application programming interface (API), obtain the default screen resolution of the currently running application, and determine the screen change information of the electronic device from the current screen parameters to the target screen parameters based on the default screen resolution of the currently running application.

At S102, the touch control display area of the electronic device is configured at least based on the screen change information to respond to a target touch operation using the configured target touch display area. The target touch display area is at least a part of display area of the display screen of the electronic device.

In some embodiments, when the touch display area of the electronic device is configured, the size, touch response speed, sensitivity, resolution, accuracy, control manner (controlled by a touch controller or a virtual control firmware), area position (e.g., switch screens) of the display area can be adjusted.

In some embodiments, the touch display area of the electronic device can be configured only based on the screen change information.

In some other embodiments, the touch display area of the electronic device can be configured based on the screen change information and operation information of the electronic device, such as the type of application running on the electronic device, user habits, etc.

In some embodiments, when the area position of the touch display area is adjusted at least based on the screen change information, the display screen of the electronic device can include at least one screen. As shown in FIG. 2, the electronic device includes a plurality of screens.

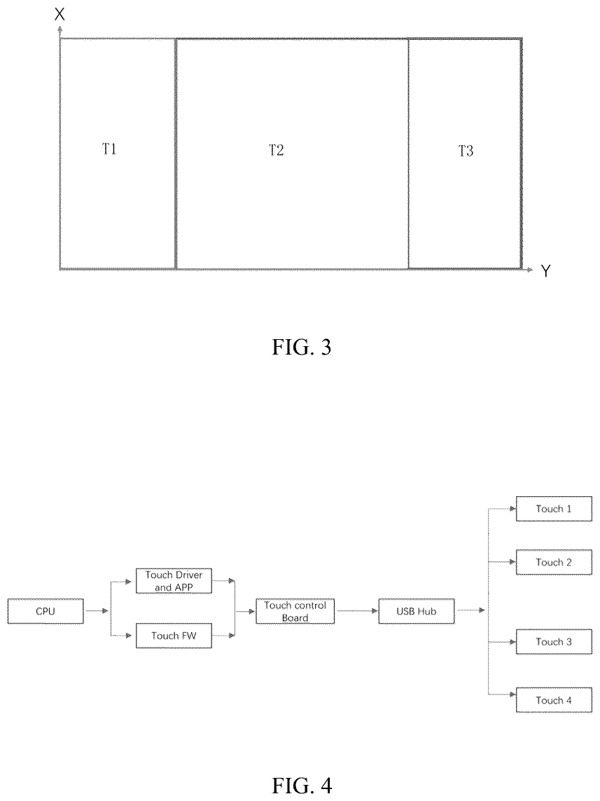

When the electronic device includes a plurality of screens, the display area of the display screen of the electronic device can be a combination of the display areas of all screens of the electronic device. For example, the display screen of the electronic device can include 3 screens. The display area of the display screen of the electronic device is the combination of the display areas of the three screens shown in FIG. 3. T1 represents the display area of the screen of the electronic device. T2 represents the display area of another screen of the electronic device. T3 represents the display area of another screen of the electronic device. The target touch display area can be the display area of one screen, the display areas of the plurality of screens, a partial display area of one screen, or a part of display areas of the plurality of screens.

In the control method of embodiments of the present disclosure, the screen change information of the electronic device can be obtained. At least based on the screen change information, the touch display area of the electronic device can be configured. The target touch operation can be responded to using the configured target touch display area. The target touch display area can be a part of display area of the display screen of the electronic device. Thus, the touch display area of the electronic device can be adjusted based on the screen change information of the electronic device to cause the adjusted target display area to respond to the target touch operation. Thus, the user can conveniently perform the touch operation on the changed screen after the screen size, form, or resolution is changed, which can improve the operability and interactivity of the electronic device to improve the user experience.

In some embodiments, in step S101, obtaining the screen change information of the electronic device can include determining pose change information of at least one second screen that moves relative to a first screen of the electronic device, the second screen moving from an edge of the first screen relative to the first screen, and determining the pose change information as the screen change information.

In step S102, configuring the touch display area of the electronic device based on the screen change information can include, if the screen change information indicates that the at least one second screen of the electronic device moves from a first pose to a second pose, configuring at least a part of display area of the second screen and/or the first screen as the target touch display area of the electronic device.

In some embodiments, the display screen of the electronic device can include the first screen and the at least one second screen. The pose change information of the second screen can include but is not limited to unfolded size change information and angle change information relative to the first screen of the second screen. By determining the pose change information as the screen change information, when the pose of the second screen changes, the touch display area of the electronic device can be automatically configured.

In some embodiments, at least a part of display area of the second screen and/or the first screen can be configured as the target touch display area of the electronic device. The first screen can continue to be configured as the target touch display area, the at least one second screen can be configured as the target touch display area, or the first screen and the second screen both can be configured as the target touch display area.

For example, when the unfolded size of the second screen is determined to change from a first size to a second size that is larger, or the angle relative to the first screen is determined to change from a first angle to a second angle that is larger, the first screen can continue to be configured as the target touch display area. When the unfolded size of the second screen is determined to change from the second size to a third size that is smaller, or the angle of the first screen is determined to change from the second angle to a third angle that is smaller, the at least one second screen can be configured as the target touch display area. When the unfolded size of the second screen is determined to change from the second size to a fourth size that is larger, or the angle relative to the first screen is determined from the second angle to a fourth angle that is larger, the first screen and the second screen both can be configured as the target touch control area.

In some embodiments, configuring at least a part of display area of the second screen and/or the first screen as the target touch display area of the electronic device as the target touch display area of the electronic device can include obtaining target reference information, and configuring the at least a part of display area of the at least one second screen and/or the first screen as the target touch display area based on the target reference information.

In some embodiments, the target reference information can include, but is not limited to, attribute information of a to-be-displayed content, e.g., whether the electronic device needs to be controlled to realize the corresponding function, such as switch view angle, zoom in, zoom out, volume adjustment, and brightness adjustment. Based on the target reference information, at least a part of display area of the at least one second screen and/or the first screen can be configured as the target touch display area. Thus, when the pose of the second screen changes, the touch display area of the electronic device can be configured automatically based on the to-be-displayed content to cause the configured target touch display area to satisfy the display requirements of the to-be-displayed content.

In some embodiments, if the target reference information indicates that the target to-be-displayed content has a first attribute parameter, the display area of the first screen can be configured as the target touch display area. If the target reference information indicates that the target to-be-displayed content has the second attribute parameter, the display areas of the first screen and the at least one second screen can be configured as the target touch display area. If the target reference information indicates that the target to-be-displayed content has the third attribute parameter, the first display area of the at least one second screen can be configured as the target touch display area. The first display area can be a part of display area of the second screen and can be configured to display a controllable object of the target to-be-displayed content. If the target reference information indicates that the target to-be-displayed content has the fourth attribute parameter, a second display area of the first screen and one second screen can be configured as the target touch display area. The second display area can include the display area of the first screen and a part of display area of the second screen and can be configured to control the output parameter of the target to-be-displayed content.

The first attribute parameter can indicate that the target to-be-displayed content has non-interactivity and is only used for display. If the target to-be-displayed content can be a text file, an image, or a 3D image, the target to-be-displayed content can have the first attribute parameter. When the target to-be-displayed content has the first attribute parameter, the display area of the first screen can be configured as the target touch display area. For example, for the 3D image, the view angle can be switched intelligently through the first screen.

The second attribute information can indicate that the whole image content can be interacted with or may need to be positioned and controlled. If the target to-be-displayed content is a game map of a game application, the target to-be-displayed content can have the second attribute parameter. If the whole image content of the target to-be-displayed content is able to be interacted with or needs to be positioned and controlled, the whole display area of the electronic device can be configured as the target touch display area.

The third attribute information can indicate that the target to-be-displayed content is a video content or a conference application (the functional area can be interacted with, and other areas cannot be controlled). If the target to-be-displayed content is the video content or a conference application, a part of display area of the at least one second screen can be configured as the target touch display area, which is configured to display the functional area for outputting the target to-be-displayed content.

The fourth attribute information can indicate that the target to-be-displayed content is a video or audio content. The output parameter of the to-be-displayed content can include, but is not limited to, volume, play speed, and brightness. If the target to-be-displayed content is a video or audio content, a part of display area of the first screen and a part of display area of the second screen can be configured as the target touch display area for volume adjustment, play speed adjustment, and brightness adjustment.

Thus, for different target to-be-displayed contents, different display areas can be configured as the target touch display area to conform to the attribute of the target to-be-displayed content to improve the user experience.

In some other embodiments, configuring at least a part of display area of the second screen and/or the first screen as the target touch display area of the electronic device can include obtaining the target reference information and hardware configuration information of the second screen, and configuring at least a part of display area of the at least one second screen and/or the first screen as the target touch display area based on the target reference information and the hardware configuration information.

In some embodiments, the target reference information can include but is not limited to the attribute information of the to-be-displayed content, e.g., whether the to-be-displayed content needs to be controlled to realize the corresponding function, such as view angle switching, zoom in, zoom out, volume adjustment, and brightness adjustment. The hardware configuration information can include but is not limited to screen size, response speed, sensitivity, resolution, accuracy, and touch controller.

In some embodiments, the hardware configuration information of the first screen can be obtained.

In some embodiments, based on the target reference information and the hardware configuration information, at least a part of display area of the at least one second screen and/or the first screen can be configured as the target touch display area. Thus, the target touch display area corresponding to the target to-be-displayed content can be quickly and accurately configured from the first screen and the second screen.

In some embodiments, configuring at least a part of display area of the at least one second screen and/or the first screen as the target touch control display can include, based on the attribute parameter of the target to-be-displayed content represented by the target reference information and the display configuration parameter of the second screen, configuring the at least a part of display area of the at least one second screen and/or the first screen as the target touch display area.

In some embodiments, the attribute parameter can include a display size and resolution. The display configuration parameter can include a screen size and resolution.

In some embodiments, the display configuration parameter of the first screen can be obtained.

In some embodiments, the display size and resolution corresponding to the target to-be-displayed content can be obtained. The screen size and resolution of the first screen can be obtained. The screen size and resolution of the second screen can be obtained. Then, the display size and resolution of the target to-be-displayed content can be compared to the screen sizes and resolutions of the first screen and the second screen. For example, the display size of the target to-be-displayed content can be 21 inches, and the resolution can be 1000×1000. The screen size of the first screen can be 10 inches, and the resolution can be 500×500. The screen size of a second screen can be 12 inches, and the resolution can be 500×500. The screen size of another second screen can be 15 inches, and the resolution can be 600×600. The combined screen size corresponding to the first screen and the second screen of 12 inches and the sum of the resolutions can be similar to or equal to the display size and the resolution of the target to-be-displayed content. Thus, the display area corresponding to the first screen and the second screen of 12 inches can be determined as the target touch display area.

In some embodiments, according to the sizes and resolutions of the first screen and the second screen, which screen or which combination of the screens is used as the target touch display area can be determined. Thus, the target touch display area corresponding to the target to-be-displayed content can be quickly and accurately matched.

In some embodiments, in step S101, obtaining the screen change information of the electronic device can include obtaining configuration update information applied to the electronic device and used to adjust the touch display parameter of the electronic device and determining the configuration update information as the screen change information.

In step S102, configuring the touch display area of the electronic device based on the screen change information can include, if the screen change information represents that the electronic device is updated from a first touch display parameter to a second touch display parameter, configuring the display area matching the second touch display parameter as the target touch display area of the electronic device.

In some embodiments, the configuration update information of the touch display parameter can include but is not limited to update information such as touch area size, touch response speed, resolution, sensitivity, etc. The configuration update information of the touch display parameter can be adjusted on the touch driver interface or inputted on a configuration interface of a specific application.

In some embodiments, the matched screen area can be determined based on the change in the touch display parameter to reconfigure the target touch display area.

In some embodiments, configuring the display area matching the second touch display parameter of the target touch display area of the electronic device can include determining the size and/or resolution of the screen of the electronic device, determining the target screen matching the second touch display parameter based on the size and/or resolution of the screen to configure the target touch display area using the target touch controller of the electronic device. The target touch controller may belong to or may not belong to the target screen.

In some embodiments, as shown in FIG. 4, a central processor (CPU) enables the touch driver and the specific application (APP) to cause the touch driver and the APP to recognize the changes in the touch area size and/or resolution in real-time. When the touch driver and APP detect the changes in the touch area size and/or resolution, the touch area size and/or resolution can be determined to match the size and/or resolution of which screen or a combination of screens. After the target screen is determined, the target touch controller (touch control board) can be notified by the touch firmware (touch FW). The target touch controller can configure the display area (e.g., touch 1 and touch 2) of the target screen as the target touch display area through a USB Hub. The target touch controller (touch control board) may not belong to the target screen, and the plurality of screens can share a target touch controller.

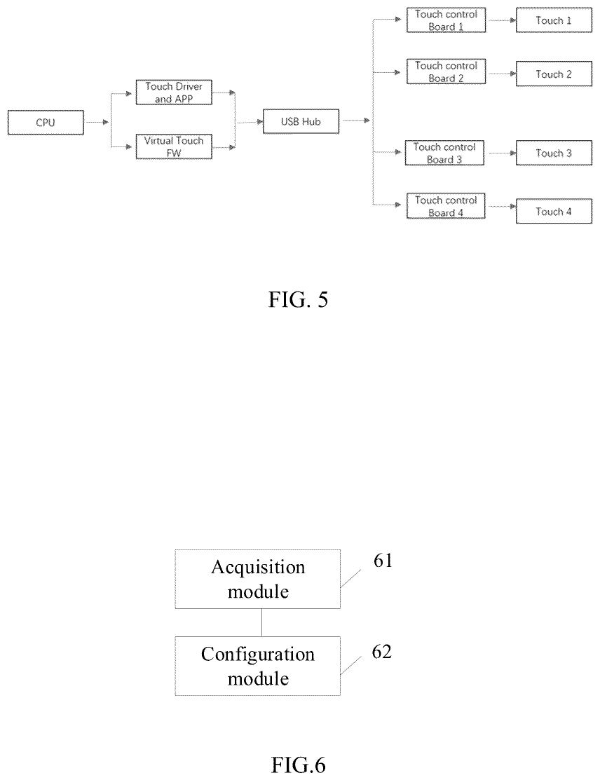

In some other embodiments, as shown in FIG. 5, the CPU enables the touch driver and the APP to cause the touch driver and the APP to recognize the changes in the touch area size and/or resolution in real-time. When the touch driver and the APP detect the changes in the touch area size and/or resolution, the matched size and resolution can be determined to correspond to which screen or a combination of screens. After the target screen is determined, the target touch controllers (e.g., touch control board 1 and touch control board 2) of the respective target screens can be notified by the virtual touch firmware (virtual touch FW) and the USB Hub. The respective target touch controller of the target screen can configure the display area of the target screen as the target touch display area (e.g., touch control board 1 configures touch 1 as a target touch display area, and touch control board 2 configures touch 2 as a target touch display area). The target touch controller can belong to the target screen.

For example, an electronic device can include touch areas (touch display screens) Touch 1, Touch 2, and Touch 3. Touch 1 can correspond to a resolution of 500×500. Touch 2 can correspond to a resolution of 800×800. Touch 3 can correspond to a resolution of 1000×1000. In a sequence from Touch 1 to Touch 3, whether the resolutions of Touch 1 to Touch 3 match the resolution of 1000×1000 can be determined. If no matching is found, determination can continue to be performed on a combination of Touch 1 and Touch 2, a combination of Touch 2 and Touch 3, a combination of Touch 1 and Touch 3, a combination of Touch 1, Touch 2, and Touch 3, until a target screen with the resolution matching the resolution of 1000×1000 can be determined. Through the determination, the combination of Touch 1 and Touch 2 can be determined to have a resolution matching the resolution of 1000×1000. Thus, the combination of Touch 1 and Touch 2 can be determined as the target screen. Then, the target touch controller (touch control board) can be notified through the touch firmware (touch FW). The target touch controller can configure the display area of Touch 1 and Touch 2 as the target touch display area through the USB Hub.

Thus, the size and/or resolution of the target touch display area can be matched with the second touch display parameter.

In some embodiments, in step S101, obtaining the screen change information of the electronic device can include obtaining running application change information of the electronic device, and determining the screen change information based on the running application change information.

In step S102, configuring the touch display area of the electronic device based on the screen change information can include, if the application running on the electronic device changes, configuring the target touch display area of the electronic device based on the operation parameter of the target application.

In some embodiments, configuring the target touch display area of the electronic device based on the operation parameter of the target application can include obtaining the touch configuration parameters of screens of the electronic device, determining the target screen matching the operation parameter of the target application based on the touch configuration parameter to configure the target touch display area and the touch parameter using the target touch controller of the electronic device. The target touch controller can belong to or not belong to the target screen.

In some embodiments, the touch configuration parameter can include touch sensitivity, response speed, area, resolution, etc. The operation parameter of the target application can include touch resolution, sensitivity, response time, etc. After obtaining the touch sensitivities, response speeds, areas, and resolutions of the screens of the electronic device, the screen matching and area can be determined, and the touch parameter can be configured.

In some embodiments, when obtaining the operation application change information of the electronic device, the touch sensitivity, response speed, area, resolution, etc. required by the target application can be determined. Then, the touch sensitivities, response speeds, areas, and resolutions of the screens of the electronic device can be determined. One or more screens that match the touch sensitivity, response speed, area, and resolution required by the target application can be determined as the target screen. For example, the touch sensitivities, response speeds, areas, and resolutions corresponding to screen 1 and screen 2 can match the touch sensitivity, response speed, area, and resolution required by the target application, Then, screen 1 and screen 2 can be determined as the target screen, and the display areas corresponding to screen 1 and screen 2 can be determined as the target touch display area.

In some embodiments, the required screen size and/or screen resolution can be determined according to an application that is newly running to configure the target touch area using the required screen size and/or resolution.

In some embodiments, in step S101, obtaining the screen change information of the electronic device can include obtaining use object change information of the electronic device, and determining the screen change information based on the use object change information.

In step S102, configuring the touch display area of the electronic device based on the screen change information can include, if the use object of the electronic device changes, configuring the target touch display area of the electronic device based on user portrait information and/or quantity of a target use object.

In some embodiments, the use object change information can include but is not limited to user habits or device use scenario change information.

In some embodiments, the user portrait information can mainly include use habits. For example, the habits of the target use object can include a preference for full-screen touch or small-screen touch.

In some embodiments, configuring the target touch display area of the electronic device based on the user portrait information and/or quantity of the target use object can include, if the target use object is unique, configuring the target touch display area based on the user portrait information of the target use object, if the target use object is not unique, configuring the first screen and the at least one second screen of the electronic device as the target touch display area, and if the target use object is not unique, configuring the target touch display area based on a statistical result of the user portrait information of the non-unique target use object. The statistical result can be a result of performing statistics on user preferences or habits, which can be calculated in terms of quantity proportion.

For example, when the target user is a person, the use habits of the target use object can be determined. If the target use object gets used to the small screen touch, the first screen of the electronic device can be configured as the target touch display area. If the target use object includes two persons, the first screen and the at least one second screen of the electronic device can be configured as the target touch display area.

In some embodiments, the screen can be configured as the target touch display area based on the user habits.

In some embodiments, in step S101, obtaining the screen change information of the electronic device can include determining the size change information of the first screen of the electronic device, and determining the size change information as the screen change information.

In step S102, configuring the touch display area of the electronic device based on the screen change information can include, if the screen change information represents that the size of the first screen of the electronic device is updated from a first size to a second size, configuring the display area matching the second size as the target touch display area of the electronic device.

In some embodiments, for example, if the size of the first screen is updated from 20 inches to 25 inches, a display area corresponding to the size of 25 inches can be randomly determined from the first screen or the at least one second screen. The display area can be configured as the target touch display area.

In some embodiments, in step S102, configuring the touch display area of the electronic device at least based on the screen change information can include adjusting, by the first touch controller of the first screen of the electronic device, the control range of the first touch controller based on the size and/or resolution of the target screen to obtain the target touch display area. The target screen can include the first screen and the at least one second screen of the electronic device. The target touch display area can include at least two touch areas. The first touch controller can simultaneously respond to the touch operations applied to the at least two touch areas.

In some embodiments, as shown in FIG. 4, the first screen and the at least one second screen share a target touch controller, that is, the first touch controller. The first touch controller can configure the display area of the target screen (e.g., Touch 1 and Touch 2) as the target touch display area through a USB Hub. The first touch controller can simultaneously respond to touch operations applied in at least two touch areas.

In some embodiments, each screen can use the first touch controller to respond to the touch operation of each screen. Thus, only one touch controller can be configured to realize the touch operations on all screens.

In some embodiments, in step S102, configuring the touch display area of the electronic device at least based on the screen change information can include providing the size and/or resolution of the target screen of the electronic device to the second touch controllers of the target screens to cause the second touch controllers to adjust the control ranges of the second touch controllers to obtain the target touch display area. The target screen can include the first screen and the at least one second screen of the electronic device. The target touch display area can include at least two touch areas. The touch areas can respond to the touch operations applied to the areas through the second touch controllers of the touch areas.

In some embodiments, as shown in FIG. 5, each screen corresponds to a second touch controller, that is, the target touch controller. The first screen, e.g., Touch 1, corresponds to a second touch controller, such as Touch control board 1. A second screen, e.g., Touch 2, corresponds to a second touch controller, such as Touch control board 2. The size and/or resolution of the target screen of the electronic device can be notified to the corresponding second touch controllers of the target screens through the virtual touch firmware (Virtual Touch FW) and USB Hub. The second touch controllers corresponding to the target screens can configure the display area of the target screen as the target touch display area (e.g., Touch control board 1 configures Touch 1 as the target touch display area, and Touch control board 2 configures Touch 2 as the target touch display area) to obtain the target touch display area.

In some embodiments, the screens can use the second touch controllers corresponding to the screens to respond to the touch operations on the areas. Thus, the touch operations for the areas can be accurately controlled.

Embodiments of the present disclosure also provide a control apparatus. As shown in FIG. 6, the apparatus includes an acquisition module 61, and a configuration module 62.

The acquisition module 61 can be configured to obtain the screen change information of the electronic device.

The configuration module 62 can be configured to configure the touch display area of the electronic device at least based on the screen change information to respond to the target touch operation by the configured target touch display area. The target touch display area can be at least a part of display area of the display screen of the electronic device.

In the control apparatus of embodiments of the present disclosure, the screen change information of the electronic device can be obtained, and the touch display area of the electronic device can be configured at least based on the screen change information to respond to the target touch operation by the configured target touch display area. The target touch display area can be at least a part of display area of the display screen of the electronic device. Thus, the touch display area of the electronic device can be adjusted based on the screen change information of the electronic device to cause the adjusted target display area to respond to the target touch operation to improve the user experience.

Embodiments of the present disclosure further provide an electronic device and a readable storage medium.

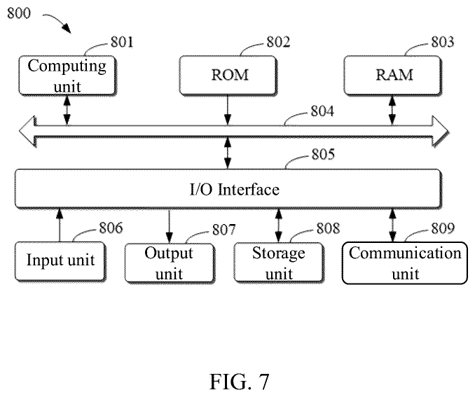

FIG. 7 illustrates a schematic hardware structural diagram of an electronic device 800 according to some embodiments of the present disclosure. The electronic device can include various types of digital computers, such as a laptop, a desktop, a workstation, a personal digital assistant, a server, a blade server, a mainframe computer, and other suitable computers. The electronic device can also include various types of mobile apparatuses, such as personal digital assistants, cellular phones, smartphones, wearable devices, and other similar computing apparatuses. The members, the connection and relationship of the members, and the functions of the members can be only used as examples and are not intended to limit the present disclosure described and/or required in the present specification.

As shown in FIG. 7, the electronic device 800 includes a computing unit 801. The computing unit 801 can be configured to perform various appropriate actions and processing according to the computer program stored in the ROM 802 and the computer program loaded into the RAM 803 from the storage unit 808. In the RAM 803, various programs and data required by the operation of the electronic device 800 can be stored. The computing unit 801, the ROM 802, and the RAM 803 can be connected to each other through the bus 804. The I/O interface 805 is also connected to the bus 804.

A plurality of members of the electronic device 800 can be connected to the I/O interface 805. The plurality of members can include an input unit 806, e.g., a keyboard, a mouse, etc., an output unit 807, e.g., various types of display screens and speakers, a storage unit 808, e.g., magnetic discs, optical discs, etc., and a communication unit 809, e.g., a network card, a modem, and a wireless communication transceiver. The communication unit 809 can allow the electronic device 800 to exchange information/data with another device through a computing network such as the Internet and/or various telecommunications networks.

The computing unit 801 can include various general-purpose and/or special-purpose processing assemblies having the processing and computing capabilities. In some embodiments, the computing unit 801 can include but is not limited to a CPU, a GPU, various special-purpose AI computing chips, various computing units running the machine learning model, a digital signal processor (DSP), and any suitable processor, controller, and microcontroller, such as touch controller. The computing unit 801 can perform the methods and processing above, e.g., a control method. For example, in some embodiments, the control method can be implemented as a computer software program. The computer software program can be stored in the machine-readable medium, e.g., a storage unit 808. In some embodiments, a part of or all of the computer program can be loaded into and/or installed at the electronic device through the ROM 802 and/or the communication unit 809. When the computer program is loaded at RAM 803 and executed by the computing unit 801, the one or more steps of the control method can be performed. In some other embodiments, the computing unit 801 can be configured to perform the control method through any other appropriate method (e.g., with the firmware).

Various embodiments of the above systems and technologies of the present disclosure can be implemented in digital electronic circuit systems, integrated circuit systems, field programmable gate arrays (FPGAs), application specific integrated circuits (ASICs), application specific standard products (ASSPs), systems on a chip (SOC), complex programmable logic device (CPLD), computer hardware, firmware, software, and/or a combination thereof. Embodiments of the present disclosure can be implemented in one or a plurality of computer programs. The one or more computer programs can be executed and/or explained in a programmable system of at least one programmable processor. The programmable processor can be a special-purpose or general-purpose programmable processor and can receive data and instructions from the storage system, at least one input apparatus, and at least one output apparatus and transfer the data and the instructions to the storage system, the at least one input apparatus, and the at least one output apparatus.

Program codes for implementing the methods of the present disclosure can be written in any combination of one or more programming languages. These program codes can be provided to a processor or controller of a general-purpose computer, special-purpose computer, or other programmable data processing apparatus. Thus, when the program codes are executed by the processor or controller, the functions/operations defined in the flowchart and/or block diagram can be implemented. The program codes can be completely or partially executed at the machine, the program codes can be partially executed at the machine as an independent software packet and partially executed at the remote machine or completely executed at the remote machine or server.

In the context of the present disclosure, the machine-readable medium can be a tangible medium, which can include or store the program for the instruction execution system, apparatus, or device to user or used in connection with the instruction execution system, apparatus, or device. The machine-readable medium can be a machine-readable signal medium or machine-readable storage medium. The machine-readable medium can include but is not limited to electrical, magnetic, optical, electromagnetic, infrared, or semiconductor system, apparatus, or device, or any appropriate assembly of the above content. The machine-readable storage medium can include electrical connections based on one or more wires, laptop disks, hard drives, random access memory (RAM), read-only memory (ROM), erasable programmable read-only memory (EPROM or flash memory), optical fiber, portable compact disk read-only memory (CD-ROM), optical storage device, magnetic storage device, or any suitable combination thereof.

To provide interaction with a user, the systems and technology can be implemented at the computer. The computer can include a display apparatus (e.g., a CRT (cathode ray tube) or LCD (liquid crystal display) monitor) configured to display information to the user and a keyboard and a pointing apparatus (e.g., a mouse or a trackball). The user can provide input to the computer through the keyboard and the pointing apparatus. Other types of apparatuses can also be configured to provide interaction with the user. For example, the feedback provided to the user can be any form of sensor feedback (e.g., visual feedback, auditory feedback, or tactile feedback). The input from the user can be received in any format (including sound input, auditory input, and tactile input).

The system and technology can be implemented at a computer system (e.g., data server) including back-end members, a computer system (e.g., application server), or a computer system (e.g., user computer including a graphic user interface or a network browser, the user can interact with the implementation of the system and technology through the graphic user interface a or the network browser, a computer system including a combination of the back-end members, intermediate members, or front-end members. Members of the system can be mutually connected with each other through the digital and data communication (e.g., communication network) of any type or medium. For example, the communication network can include a local area network (LAN), a wide area network (WAN), and the Internet.

The computer system can include a client end and a server. The client and the server are generally away from each other and typically interact with each other through the communications network. The relationship between client and server can be created by a computer program running on a corresponding computer and having a client-server relationship with each other. The server can be a cloud server, a distributed system server, or a server combined with a blockchain.

The various forms of processes shown above can be used to reorder, add or delete steps. For example, the steps of the present disclosure can be executed in parallel, in sequence, or in different orders, as long as the desired results of the technical solution of the present disclosure can be realized, which is not limited in the present disclosure.

In addition, the terms “first” and “second” are used for descriptive purposes only, and cannot be understood as indicating or implying relative importance or implicitly indicating the number of indicated technical features. Therefore, the features defined as “first” and “second” can explicitly or implicitly include at least one of the features. In the description of the present disclosure, “a plurality of” can mean two or more than two, unless otherwise clearly and specifically defined.

The above are only some embodiments of the present disclosure. However, the scope of the present disclosure is not limited to this. Those skilled in the art can easily think of modifications or substitutions. The modifications and substitutions are within the scope of the present disclosure. Thus, the scope of the present disclosure is subjected to the scope of the claims.

What is claimed is:

1. A control method comprising:
obtaining screen change information of an electronic device; and
configuring a touch display area of the electronic device at least based on the screen change information to respond to a target touch operation using the configured target touch display area;
wherein, the target touch display area is at least a part of display area of the display screen of the electronic device.

2. The method according to claim 1, wherein obtaining the screen change information of the electronic device includes at least one of:
determining pose change information of at least one second screen that moves relative to a first screen of the electronic device, the second screen moving relative to the first screen from an edge of the first screen, and determining the pose change information as the screen change information;
obtaining configuration update information for adjusting a touch display parameter of the electronic device, and determining the configuration update information as the screen change information;
obtaining running application change information of the electronic device, and determining the screen change information based on the running application change information; or
obtaining use object change information of the electronic device, and determining the screen change information based on the use object change information.

3. The method according to claim 2, wherein configuring the touch display area of the electronic device based on the screen change information includes at least one of:
in response to the screen change information indicating that the at least one second screen of the electronic device moves from a first pose to a second pose, configuring at least a part of display area of the second screen and/or the first screen as the target touch display area of the electronic device;
in response to the screen change information indicating that the electronic device is updated from a first touch display parameter to a second touch display parameter, configuring a display area matching the second touch display parameter as the target touch display area of the electronic device;
in response to an application running on the electronic device changes, configuring the target touch display area of the electronic device based on a running parameter of the target application; or
in response to the use object of the electronic device changes, configuring the target touch display area of the electronic device based on user portrait information and/or a number of the target user.

4. The method according to claim 3, wherein configuring at least a part of display area of the second screen and/or the first screen as the target touch display area of the electronic device includes at least one of:
obtaining target reference information and configuring at least part of the display area of at least one second screen and/or the first screen as the target touch display area based on the target reference information; or
obtaining the target reference information and hardware configuration information of the second screen, and configuring at least a part of display area of the at least one second screen and/or the first screen as the target touch display area based on the target reference information and hardware configuration information.

5. The method according to claim 4, wherein configuring the at least a part of display area of the at least one second screen and/or the first screen as the target touch display area includes at least one of:
in response to the target reference information representing that target to-be-displayed content has a first attribute parameter, configuring the display area of the first screen as the target touch display area;
in response to the target reference information representing that the target to-be-displayed content has a second attribute parameter, configuring the display area of the first screen and the at least one second screen as the target touch display area;
in response to the target reference information representing that the target to-be-displayed content has a third attribute parameter, configuring a first display area of the at least one second screen as the target touch display area, the first display area being a part of display area of the second screen and being configured to display a controllable object of the target to-be-displayed content;
in response to the target reference information representing that the target to-be-displayed content has a fourth attribute parameter, configuring the first screen and a second display area of one second screen as the target touch display area, the second display area including a part of display area of the first screen and a part of display area of the second screen and being configured to control an output parameter of the target to-be-displayed content; or
based on attribute parameters of the target to-be-displayed content represented by the target reference information and display configuration parameter of the second screen, configuring at least a part of display area of the at least one second screen and/or the first screen as the target touch display area.

6. The method according to claim 3, wherein configuring the display area matching the second touch display parameter as the target touch display area of the electronic device includes:
determining a size and/or resolution of a screen of the electronic device; and
determining a target screen matching the second touch display parameter based on the size and/or resolution of the screen to configure the target touch display area using the target touch controller of the electronic device, the target touch controller belonging to or not belonging to the target screen.

7. The method according to claim 3, wherein configuring the target touch display area of the electronic device based on an operation parameter of the target application includes:
obtaining touch configuration parameters of screens of the electronic device, determining the target screen matching the operation parameter of the target application based on the touch configuration parameter to configure the target touch display area and the touch parameter of the target touch display area using the target touch controller of the electronic device, the target touch controller belonging to or not belonging to the target screen; or
configuring the target touch display area of the electronic device based on user portrait information and/or number of the target use object includes at least one of:
in response to the target use object being unique, configuring the target touch display area based on the user portrait information of the target user object;
in response to the target use object being not unique, configuring the first screen and the at least one second screen of the electronic device as the target touch display area; or
in response to the target use object being not unique, configuring the target touch display area based on a statistical result of the user portrait information of the non-unique target use object.

8. The method according to claim 1, wherein configuring the touch display area of the electronic device at least based on the screen change information includes at least one of:
adjusting a control range of a first touch controller of the first screen of the electronic device based on a size and/or resolution of a target screen to obtain the target touch display area, wherein the target screen includes the first screen and the at least one second screen of the electronic device, the target touch display area includes at least two touch areas, and the first touch controller simultaneously responds to touch operations applied on the at least two touch areas; or
providing the size and/or resolution of the target screen of the electronic device to a second touch controller of the target screen to allow the second touch controller to adjust a control range of the second touch controller to obtain the target touch display area, wherein the target screen includes the first screen and the at least one second screen of the electronic device, the target touch display area includes the at least two touch areas, and the touch areas respond to the touch operations applied on the touch areas through second touch controllers, respectively.

9. A control apparatus comprising:
an acquisition module configured to obtain screen change information of an electronic device; and
a configuration module configured to configure a touch display area of the electronic device at least based on the screen change information to respond to a target touch operation using the configured target touch display area;
wherein, the target touch display area is at least a part of display area of a display screen of the electronic device.

10. The control apparatus according to claim 9, wherein the acquisition module is configured to at least one of:
determine pose change information of at least one second screen that moves relative to a first screen of the electronic device, the second screen moving relative to the first screen from an edge of the first screen, and determine the pose change information as the screen change information;
obtain configuration update information for adjusting a touch display parameter of the electronic device, and determine the configuration update information as the screen change information;
obtain running application change information of the electronic device, and determine the screen change information based on the running application change information; or
obtain use object change information of the electronic device, and determine the screen change information based on the use object change information.

11. The control apparatus according to claim 10, wherein the configuration module is configured to at least one of:
in response to the screen change information indicating that the at least one second screen of the electronic device moves from a first pose to a second pose, configure at least a part of display area of the second screen and/or the first screen as the target touch display area of the electronic device;
in response to the screen change information indicating that the electronic device is updated from a first touch display parameter to a second touch display parameter, configure a display area matching the second touch display parameter as the target touch display area of the electronic device;
in response to an application running on the electronic device changes, configure the target touch display area of the electronic device based on a running parameter of the target application; or
in response to the use object of the electronic device changes, configure the target touch display area of the electronic device based on user portrait information and/or number of the target user.

12. The control apparatus according to claim 11, wherein the configuration module is configured to at least one of:
obtain target reference information, and configure at least part of the display area of at least one second screen and/or the first screen as the target touch display area based on the target reference information; or
obtain the target reference information and hardware configuration information of the second screen, and configure at least a part of display area of the at least one second screen and/or the first screen as the target touch display area based on the target reference information and hardware configuration information.

13. An electronic device comprising:
a display screen;
a touch controller; and
a processor configured to:
obtain screen change information of the electronic device; and
configure a touch display area of the electronic device at least based on the screen change information to respond to a target touch operation using the configured target touch display area;
wherein, the target touch display area is at least a part of display area of the display screen of the electronic device.

14. The device according to claim 13, wherein the processor is further configured to at least one of:
determine pose change information of at least one second screen that moves relative to a first screen of the electronic device, the second screen moving relative to the first screen from an edge of the first screen, and determine the pose change information as the screen change information;
obtain configuration update information for adjusting a touch display parameter of the electronic device, and determine the configuration update information as the screen change information;
obtain running application change information of the electronic device, and determine the screen change information based on the running application change information; or
obtain use object change information of the electronic device, and determine the screen change information based on the use object change information.

15. The device according to claim 14, wherein the processor is further configured to at least one of:
in response to the screen change information indicating that the at least one second screen of the electronic device moves from a first pose to a second pose, configure at least a part of display area of the second screen and/or the first screen as the target touch display area of the electronic device;
in response to the screen change information indicating that the electronic device is updated from a first touch display parameter to a second touch display parameter, configure a display area matching the second touch display parameter as the target touch display area of the electronic device;
in response to an application running on the electronic device changes, configure the target touch display area of the electronic device based on a running parameter of the target application; or
in response to the use object of the electronic device changes, configure the target touch display area of the electronic device based on user portrait information and/or a number of the target user.

16. The device according to claim 15, wherein the processor is further configured to at least one of:
obtain target reference information, and configure at least part of the display area of at least one second screen and/or the first screen as the target touch display area based on the target reference information; or
obtain the target reference information and hardware configuration information of the second screen, and configure at least a part of display area of the at least one second screen and/or the first screen as the target touch display area based on the target reference information and hardware configuration information.

17. The device according to claim 16, wherein the processor is further configured to at least one of:
in response to the target reference information representing that target to-be-displayed content has a first attribute parameter, configure the display area of the first screen as the target touch display area;
in response to the target reference information representing that the target to-be-displayed content has a second attribute parameter, configure the display area of the first screen and the at least one second screen as the target touch display area;
in response to the target reference information representing that the target to-be-displayed content has a third attribute parameter, configure a first display area of the at least one second screen as the target touch display area, the first display area being a part of display area of the second screen and being configured to display a controllable object of the target to-be-displayed content;
in response to the target reference information representing that the target to-be-displayed content has a fourth attribute parameter, configure the first screen and a second display area of one second screen as the target touch display area, the second display area including a part of display area of the first screen and a part of display area of the second screen and being configured to control an output parameter of the target to-be-displayed content; or
based on attribute parameters of the target to-be-displayed content represented by the target reference information and display configuration parameter of the second screen, configure at least a part of display area of the at least one second screen and/or the first screen as the target touch display area.

18. The device according to claim 15, wherein the processor is further configured to:
determine a size and/or resolution of a screen of the electronic device; and
determine a target screen matching the second touch display parameter based on the size and/or resolution of the screen to configure the target touch display area using the target touch controller of the electronic device, the target touch controller belonging to or not belonging to the target screen.

19. The device according to claim 15, wherein the processor is further configured to:
obtain touch configuration parameters of screens of the electronic device, and determine the target screen matching the operation parameter of the target application based on the touch configuration parameter to configure the target touch display area and the touch parameter of the target touch display area using the target touch controller of the electronic device, the target touch controller belonging to or not belonging to the target screen; or
in response to the target use object being unique, configure the target touch display area based on the user portrait information of the target user object;
in response to the target use object being not unique, configure the first screen and the at least one second screen of the electronic device as the target touch display area; or
in response to the target use object being not unique, configure the target touch display area based on a statistical result of the user portrait information of the non-unique target use object.

20. The device according to claim 13, wherein the processor is further configured to at least one of:
adjust a control range of a first touch controller of the first screen of the electronic device based on a size and/or resolution of a target screen to obtain the target touch display area, wherein the target screen includes the first screen and the at least one second screen of the electronic device, the target touch display area includes at least two touch areas, and the first touch controller simultaneously responds to touch operations applied on the at least two touch areas; or
provide the size and/or resolution of the target screen of the electronic device to a second touch controller of the target screen to allow the second touch controller to adjust a control range of the second touch controller to obtain the target touch display area, wherein the target screen includes the first screen and the at least one second screen of the electronic device, the target touch display area includes the at least two touch areas, and the touch areas respond to the touch operations applied on the touch areas through second touch controllers, respectively.
